(19) United States
(12) Patent Application Publication
(10) Pub. No.: US 2024/0378245 A1
(43) Pub. Date: Nov. 14, 2024

(54) METHOD AND APPARATUS OF TRAINING CLASSIFICATION MODEL, CLASSIFICATION METHOD, CLASSIFICATION APPARATUS, ELECTRONIC DEVICE, AND MEDIUM

(71) Applicant: BOE TECHNOLOGY GROUP CO., LTD., Beijing (CN)

(72) Inventor: Chunhui Zhang, Beijing (CN)

(21) Appl. No.: 18/260,156

(22) PCT Filed: Jul. 22, 2022
(86) PCT No.: PCT/CN2022/107284

§ 371 Date: Jun. 30, 2023

(51) Int. Cl. G06F 16/906; G06N 3/0455; G06N 3/0985

(52) U.S. Cl. CPC G06F 16/906; G06N 3/0455; G06N 3/0985

(57) ABSTRACT

A method and an apparatus of training a classification model, a classification method, a classification apparatus, an electronic device, and a medium are provided. The method includes: processing first sample data by using an auto-encoding module, so as to obtain reconstructed sample data, wherein the auto-encoding module includes at least one autoencoder, the autoencoder includes an encoder and a decoder, and the first sample data includes medical sample data; processing first sample feature data of the first sample data by using a classification module, so as to obtain a first sample classification result; jointly training the auto-encoding module and the classification module according to the first sample data, the reconstructed sample data, the first sample classification result, and a first sample classification label value of the first sample data; and obtaining the classification model according to the trained encoder and the trained classification module.

### CROSS-REFERENCE TO RELATED APPLICATION(S)

This application is a Section 371 National Stage Application of International Application No. PCT/CN2022/107284, filed on Jul. 22, 2022, entitled “METHOD AND APPARATUS OF TRAINING CLASSIFICATION MODEL, CLASSIFICATION METHOD, CLASSIFICATION APPARATUS, ELECTRONIC DEVICE, AND MEDIUM”, the content of which is incorporated herein by reference in its entirety.

### TECHNICAL FIELD

The present disclosure relates to a field of an artificial intelligence technology, in particular to a method and an apparatus of training a classification model, a classification method, a classification apparatus, an electronic device, and a medium.

### BACKGROUND

With a development of the artificial intelligence technology, the artificial intelligence technology has been widely applied in various fields. For example, in a field of medicine, it is possible to process medical data by using a classification model trained by the artificial intelligence technology to obtain a classification result, so as to perform subsequent processing according to the classification result.

### SUMMARY

In view of this, the present disclosure provides a method and an apparatus of training a classification model, a classification method, a classification apparatus, an electronic device, and a medium.

According to an aspect of the present disclosure, a method of training a classification model is provided, including: processing first sample data by using an auto-encoding module, so as to obtain reconstructed sample data, wherein the auto-encoding module includes at least one autoencoder, the autoencoder includes an encoder and a decoder, and the first sample data includes medical sample data: processing first sample feature data of the first sample data by using a classification module, so as to obtain a first sample classification result: jointly training the auto-encoding module and the classification module according to the first sample data, the reconstructed sample data, the first sample classification result, and a first sample classification label value of the first sample data; and obtaining the classification model according to the trained encoder and the trained classification module.

According to another aspect of the present disclosure, a classification method is provided, including: acquiring target data, wherein the target data includes medical target data; and inputting the target data into a classification model to obtain a classification result, wherein the classification model is trained using the method described above.

According to another aspect of the present disclosure, an electronic device is provided, including: one or more processors; and a memory for storing one or more programs, wherein the one or more programs are configured to, when executed by the one or more processors, cause the one or more processors to implement the methods described above.

According to another aspect of the present disclosure, a computer readable storage medium having computer executable instructions therein is provided, and the instructions are configured to, when executed by a processor, cause the processor to implement the methods described above.

According to another aspect of the present disclosure, a computer program product containing a computer program, wherein the computer program is configured to, when executed by a processor, cause the processor to implement the methods described above.

### BRIEF DESCRIPTION OF THE DRAWINGS

The above and other objectives, features and advantages of the present disclosure will be clearer with following descriptions of the present disclosure with reference to the accompanying drawings, in which:

FIG. 1 schematically shows an exemplary system architecture to which a method and an apparatus of training a classification model, a classification method, and a classification apparatus may be applied according to embodiments of the present disclosure;

FIG. 2 schematically shows a flowchart of a method of training a classification model according to embodiments of the present disclosure;

FIG. 3A schematically shows an example schematic diagram of a training process of a classification model according to embodiments of the present disclosure:

FIG. 3B schematically shows an example schematic diagram of the training process of the classification model according to other embodiments of the present disclosure:

FIG. 3C schematically shows an example schematic diagram of a model structure of an auto-encoding module according to embodiments of the present disclosure;

FIG. 3D schematically shows an example schematic diagram of a model structure of a classification module according to embodiments of the present disclosure:

FIG. 3E schematically shows an example schematic diagram of the training process of the classification model according to other embodiments of the present disclosure:

FIG. 3F schematically shows an example schematic diagram of the training process of the classification model according to other embodiments of the present disclosure:

FIG. 4 schematically shows a flowchart of a classification method according to embodiments of the present disclosure:

FIG. 5 schematically shows an example schematic diagram of a classification process according to embodiments of the present disclosure:

FIG. 6 schematically shows a block diagram of an apparatus of training a classification model according to embodiments of the present disclosure;

FIG. 7 schematically shows a block diagram of a classification apparatus according to embodiments of the present disclosure; and

FIG. 8 schematically shows a block diagram of an electronic device suitable for implementing the method of training the classification model and the classification method according to embodiments of the present disclosure.

### DETAILED DESCRIPTION OF EMBODIMENTS

Embodiments of the present disclosure will be described below with reference to the accompanying drawings. It should be understood, however, that these descriptions are merely exemplary and are not intended to limit the scope of the present disclosure. In the following detailed description, for ease of interpretation, many specific details are set forth to provide a comprehensive understanding of embodiments of the present disclosure. However, it is clear that one or more embodiments may also be implemented without these specific details. In addition, in the following description, descriptions of well-known structures and technologies are omitted to avoid unnecessarily obscuring the concepts of the present disclosure.

Terms used herein are for the purpose of describing specific embodiments only and are not intended to limit the present disclosure. The terms “including”, “containing”, etc. used herein indicate the presence of the feature, step, operation and/or component, but do not exclude the presence or addition of one or more other features, steps, operations or components.

All terms used herein (including technical and scientific terms) have the meanings generally understood by those skilled in the art, unless otherwise defined. It should be noted that the terms used herein shall be interpreted to have meanings consistent with the context of this specification, and shall not be interpreted in an idealized or overly rigid manner.

In a case of using the expression similar to “at least one of A, B and C”, it should be explained according to the meaning of the expression generally understood by those skilled in the art (for example, “a system including at least one of A, B and C” should include but not be limited to a system including A alone, a system including B alone, a system including C alone, a system including A and B, a system including A and C, a system including B and C, and/or a system including A, B and C). In a case of using the expression similar to “at least one of A, B or C”, it should be explained according to the meaning of the expression generally understood by those skilled in the art (for example, “a system including at least one of A, B or C” should include but not be limited to a system including A alone, a system including B alone, a system including C alone, a system including A and B, a system including A and C, a system including B and C, and/or a system including A, B and C).

Medical data has characteristics of high noise, multivariate high-dimension, and multi-source heterogeneity. For example, medical data may include at least one of multi-omics data or medical image data. The medical data may be processed using a classification model to obtain a classification result, so as to provide a basis for medical research and diagnosis according to the classification result.

Embodiments of the present disclosure propose a solution for training a classification model. For example, first sample data is processed by using an auto-encoding module, so as to obtain reconstructed sample data. The auto-encoding module includes at least one autoencoder. The autoencoder includes an encoder and a decoder. The first sample data includes medical sample data. First sample feature data of the first sample data is processed by using a classification module, so as to obtain a first sample classification result. The auto-encoding module and the classification module are jointly trained according to the first sample data, the reconstructed sample data, the first sample classification result, and a first sample classification label value of the first sample data. The classification model is obtained according to the trained encoder and the trained classification module.

According to embodiments of the present disclosure, by jointly training the auto-encoding module and the classification module according to the first sample data, the reconstructed sample data, the first sample classification result, and the first sample classification label value of the first sample data, an error transmission and an error accumulation caused by independent training of the auto-encoding module and the classification model may be reduced. In addition, since the first sample classification label value is a supervised label value, the supervised label value of the classification module may be introduced into the auto-encoding module in the joint training process of the auto-encoding module and the classification module, and then problems of the unsupervised auto-encoding module and an easy loss of features may be effectively solved. Based on the above two aspects, an accuracy of the classification model may be improved. Due to the reduction of error transmission and error accumulation caused by independent training of the auto-encoding module and the classification model, a number of model iterations is reduced, and a training speed of the model is improved, so that a data processing capacity of an electronic device such as a processor is reduced, and a processing efficiency of the electronic device such as the processor is improved. In addition, a cost of training and optimizing subsequent models is also reduced, and then an effect of improving an internal performance of the electronic device in accordance with natural laws is obtained, thereby enhancing a core competitiveness of the electronic device.

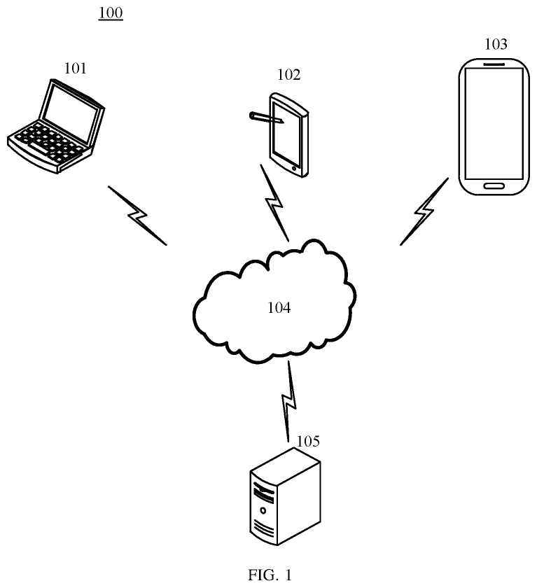

FIG. 1 schematically shows an exemplary system architecture to which a method and an apparatus of training a classification model, a classification method and a classification apparatus may be applied according to embodiments of the present disclosure.

It should be noted that FIG. 1 is merely an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios. For example, in other embodiments, the exemplary system architecture to which a method and an apparatus of training a classification model, a classification method and a classification apparatus may include a terminal device, but the terminal device may implement the method and the apparatus of training the classification model, the classification method and the classification apparatus provided in embodiments of the present disclosure without interacting with a server.

As shown in FIG. 1, a system architecture 100 according to such embodiments may include terminal devices 101, 102 and 103, a network 104, and a server 105. The network 104 is a medium for providing a communication link between the terminal devices 101, 102, 103 and the server 105. The network 104 may include various connection types, such as wired and/or wireless communication links, or the like.

The terminal devices 101, 102 and 103 may be used by a user to interact with the server 105 through the network 104 to receive or send messages, etc. The terminal devices 101, 102 and 103 may be installed with various communication client applications, such as shopping applications, web browser applications, search applications, instant messaging tools, email clients and/or social platform software, etc. (just for example).

The terminal devices 101, 102 and 103 may be various electronic devices having display screens and supporting web browsing, including but not limited to smart phones, tablet computers, laptop computers, desktop computers, or the like.

The server 105 may be various types of servers that provide various services. For example, the server 105 may be a cloud server, also known as a cloud computing server or a cloud host, which is a host product in a cloud computing service system to solve shortcomings of difficult management and weak service scalability existing in a conventional physical host and VPS (Virtual Private Server) service. The server 105 may also be a server of a distributed system or a server combined with a block-chain.

It should be noted that the method of training the classification model provided in embodiments of the present disclosure may generally be performed by the server 105. Accordingly, the apparatus of training the classification model provided in embodiments of the present disclosure may be generally arranged in the server 105. The method of training the classification model provided in embodiments of the present disclosure may also be performed by a server or server cluster different from the server 105 and capable of communicating with the terminal devices 101, 102, 103 and/or the server 105. Accordingly, the apparatus of training the classification model provided in embodiments of the present disclosure may also be arranged in a server or server cluster different from the server 105 and capable of communicating with the terminal devices 101, 102, 103 and/or the server 105.

Alternatively, the method of training the classification model provided in embodiments of the present disclosure may generally be performed by the terminal device 101, 102 or 103. Accordingly, the apparatus of training the classification model provided in embodiments of the present disclosure may also be arranged in the terminal device 101, 102 or 103.

It should be noted that the classification method provided by embodiments of the present disclosure may generally be performed by the terminal device 101, 102 or 103. Accordingly, the classification apparatus provided by embodiments of the present disclosure may also be arranged in the terminal device 101, 102 or 103.

Alternatively, the classification method provided in embodiments of the present disclosure may generally be performed by the server 105. Accordingly, the classification apparatus provided in embodiments of the present disclosure may be generally arranged in the server 105. The classification method provided in embodiments of the present disclosure may also be performed by a server or server cluster different from the server 105 and capable of communicating with the terminal devices 101, 102, 103 and/or the server 105. Accordingly, the classification apparatus provided in embodiments of the present disclosure may also be arranged in a server or server cluster different from the server 105 and capable of communicating with the terminal devices 101, 102, 103 and/or the server 105.

It should be understood that the number of terminal devices, network and server shown in FIG. 1 are merely schematic. According to implementation needs, any number of terminal devices, networks and servers may be provided.

It should be noted that a sequence number of each operation in the following methods is merely used to represent the operation for ease of description, and should not be regarded as indicating an execution order of each operation. Unless explicitly stated, the methods do not need to be performed exactly in the order shown.

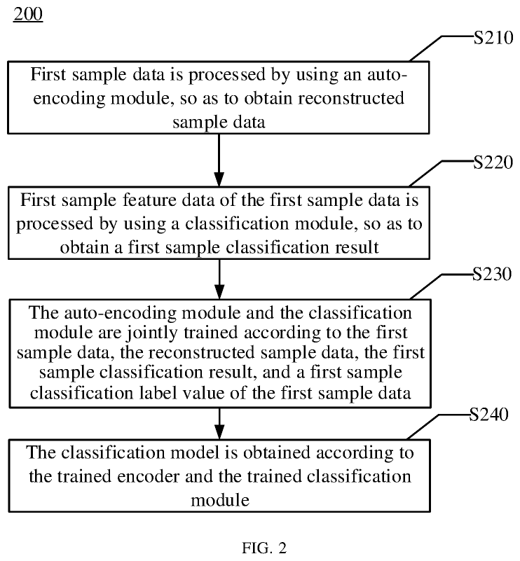

FIG. 2 schematically shows a flowchart of a method of training a classification model according to embodiments of the present disclosure.

As shown in FIG. 2, a method 200 includes operations S210 to S240.

In operation S210, first sample data is processed by using an auto-encoding module, so as to obtain reconstructed sample data. The auto-encoding module may include at least one autoencoder. The autoencoder may include an encoder and a decoder. The first sample data may include medical sample data.

In operation S220, first sample feature data of the first sample data is processed by using a classification module, so as to obtain a first sample classification result.

In operation S230, the auto-encoding module and the classification module are jointly trained according to the first sample data, the reconstructed sample data, the first sample classification result, and a first sample classification label value of the first sample data.

In operation S240, the classification model is obtained according to the trained encoder and the trained classification module.

According to embodiments of the present disclosure, data may refer to that meets at least one of the following conditions: a dimension is greater than or equal to a predetermined dimension threshold, or a redundancy meets a predetermined redundancy condition. The predetermined dimension threshold and the predetermined redundancy condition may be determined according to actual service needs and are not limited here. For example, the predetermined dimension threshold may be determined according to a statistical value from historical data. The data may include medical data. The medical data may include multi-omics data or medical image data.

According to embodiments of the present disclosure, due to a complexity of a biological system, it is difficult to fully describe the biological system through a single omics. For example, although genomics has been able to reveal a genetic change in a cancer patient, not all genetic variations may cause changes in expressions and functions. Therefore, it is difficult to deeply understand a complex biological process by simply studying changes in a particular level of biomolecules, and such situation is particularly prominent in a complex disease. With a development of a high-throughput sequencing technology, the study of omics goes deeper, and it is possible to comprehensively understand related factors of tumors and other diseases in a whole life process through an integration and analysis of multi-omics data by combining biological information, artificial intelligence and other technologies, which is a new direction of research on life mechanism.

According to embodiments of the present disclosure, omics may refer to a systematic study of a collection of various research objects, and a collection of research objects may be referred to as a “group”. Multi-omics may include at least two selected from: genomics, epigenomics, transcriptomics, proteomics, metabolomics, microbiome, or radiomics, etc. Various omics may include various types of data. For example, epigenomics may include histone modification omics, DNA (Deoxyribose Nucleic Acid) methylation omics, and chromatin accessibility omics. Multi-omics data may include tumor multi-omics data.

According to embodiments of the present disclosure, medical image data may be important data in a field of medicine, which plays an important role in assisting doctors in diagnosis and pathological research. An image classification for a medical image is a fundamental task in a medical image-based intelligent analysis. The medical image data may include at least one selected from: CT (Computerized Tomography) image data, ECT (Emission Computed Tomography) image data, PET (Positron Emission Computed Tomography) image data, MRI (Magnetic Resonance Imaging) image data, ultrasound image data, OCT (Optical Coherence Tomography) image data, or radiography data.

According to embodiments of the present disclosure, the first sample data may refer to data that meets at least one of the following conditions: a dimension is greater than or equal to a predetermined dimension threshold, or a redundancy meets a predetermined redundancy condition. The first sample data may include medical sample data. The medical sample data may include multi-omics sample data or medical sample image data.

According to embodiments of the present disclosure, the first sample data may refer to data used to train a classification model. The first sample data may include at least one first sample dimension data. The first sample data may include multi-omics sample data or medical sample image data. In a case that the first sample data is multi-omics sample data, the first sample data may include a plurality of first sample dimension data groups. The first sample dimension data group may include at least one first sample dimension data. Each omics sample data may include the first sample dimension data group corresponding to the omics sample data.

For example, the first sample data may include genomics sample data, transcriptomics sample data, proteomics sample data, and metabolomics sample data. The first sample data may include T first sample dimension data. The first sample data may include four first sample dimension data groups. T is an integer greater than or equal to 2. The number of first sample dimension data included in each first sample dimension data group may be the same or different. A 1^{st} first sample dimension data group may be a genomics sample dimension data group. A 2^{nd} first sample dimension data group may be a transcriptomics sample data group. A 3^{rd} first sample dimension data group may be a proteomics sample dimension data group. A 4^{th} first sample dimension data group may be a metabolomics sample dimension data group. The 1^{st} first sample dimension data group may include 1^{st} first sample dimension data to r^{th} first sample dimension data. The 2^{nd} first sample dimension data group may include (r+1)^{th} first sample dimension data to s^{th} first sample dimension data. The 3^{rd} first sample dimension data group may include (s+1)^{th} first sample dimension data to u^{th} first sample dimension data. The 4^{th} first sample dimension data group may include (u+1)^{th} first sample dimension data to Ti first sample dimension data. 1≤r<s<u<T, and r, s and u are all integers.

According to embodiments of the present disclosure, the first sample feature data may be obtained by performing a feature extraction on the first sample data. The first sample feature data may include at least one first sample feature dimension data.

According to embodiments of the present disclosure, in a case that the first sample data is multi-omics sample data, the reconstructed sample data may include a plurality of reconstructed sample dimension data groups. The reconstructed sample dimension data group may include at least one reconstructed sample dimension data. Each omics sample data may include a reconstructed sample dimension data group corresponding to the omics sample data.

According to embodiments of the present disclosure, the first sample classification result may include a first sample classification probability value corresponding to at least one category. There may be at least one first sample classification label value. Each category may have a first sample classification label value corresponding to that category.

According to embodiments of the present disclosure, a deep learning model may include an auto-encoding module and a classification module. The auto-encoding module may include at least one autoencoder (AE). The autoencoder may be a neural network model that allows output data (i.e., reconstructed data) to be equal to input data by using a back-propagation method. The autoencoder may include an encoder and a decoder. The encoder may be used to compress the input data into a latent spatial representation (i.e., feature data). The decoder may be used to reconstruct the latent spatial representation to obtain reconstructed data. A model structure of the autoencoder may be determined according to actual service needs and is not limited here. For example, the autoencoder may include at least one selected from: a vanillan autoencoder, a multi-layer autoencoder, a convolutional autoencoder, or a regularized autoencoder. The regularized autoencoder may include at least one of a sparse autoencoder or a denoising autoencoder.

According to embodiments of the present disclosure, the auto-encoding module may include an encoding unit and a decoding unit. The encoding unit may include at least one encoder. The decoding unit may include at least one decoder. The encoder may be an encoder in the autoencoder. The decoder may be a decoder in the autoencoder.

According to embodiments of the present disclosure, in the case that the first sample data is multi-omics sample data, the autoencoder may be used to process omics sample data corresponding to the autoencoder. For example, the first sample data may include genomics sample data, transcriptomics sample data, proteomics sample data, and metabolomics sample data. The auto-encoding module may include four autoencoders. A 1^{st} autoencoder may be used to process the genomics sample data, a 2^{nd} autoencoder may be used to process the transcriptomics sample data, a 3^{rd} autoencoder may be used to process the proteomics sample data, and a 4^{th} autoencoder may be used to process the metabolomics sample data. In addition, in the case that the first sample data is multi-omics sample data, it is possible not to distinguish between each omics sample data, and the multi-omics sample data may be processed using one autoencoder.

According to embodiments of the present disclosure, the classification module may be used to determine a classification result of data. The classification module may include at least one classifier. A model structure of the classifier may be determined according to actual service needs and is not limited here. For example, the classification model may include a decision tree model, a random forest model, a Bayesian classification model, a logical regression model, a support vector machine model, and a K-Nearest Neighbors (KNN) model. In the case that the first sample data is the multi-omics sample data, the classifier may be used to process omics sample feature dimension data corresponding to the classifier. For example, the first sample data may include genomics sample data, transcriptomics sample data, proteomics sample data, and metabolomics sample data. The classification module may include four classifiers. A 1^{st} classifier may be used to process genomic sample feature dimension data of the genomic sample data, a 2^{nd} classifier may be used to process transcriptomics sample feature dimension data of the transcriptomics sample data, a 3^{rd} classifier may be used to process proteomics sample feature dimension data of the proteomics sample data, and a 4^{th} classifier may be used to process metabolomics sample feature dimension data of the metabolomics sample data. In addition, in the case that the first sample data is the multi-omics sample data, it is possible not to distinguish between each omics sample data, and the multi-omics sample feature data of the multi-omics sample data may be processed using one classifier.

According to embodiments of the present disclosure, the first sample data may be input into the auto-encoding module to obtain reconstructed sample data. A feature extraction may be performed on the first sample data to obtain the first sample feature data. For example, the first sample data may be processed using the encoder of the auto-encoding module to obtain the first sample feature data. Alternatively, the first sample data may be processed using other feature extraction modules to obtain the first sample feature data. The first sample feature data may be input into the classification module to obtain the first sample classification result.

According to embodiments of the present disclosure, after the reconstructed sample data and the first sample classification result are obtained, the auto-encoding module and the classification module may be jointly trained according to the first sample data, the reconstructed sample data, the first sample classification result and the first sample classification label value, so as to obtain a trained auto-encoding module and a trained classification module. For example, an output value may be obtained based on a loss function according to the first sample data, the reconstructed sample data, the first sample classification result and the first sample classification label value. A model parameter of the auto-encoding module and a model parameter of the classification module may be adjusted according to the output value until a first predetermined end condition is met. The classification model may be obtained according to the trained classification module and the encoder of the trained auto-encoding module, and the classification model may include the classification module and the encoder of the auto-encoding module.

According to embodiments of the present disclosure, the method of training the classification model in embodiments of the present disclosure may be performed by an electronic device. For example, the electronic device may be a server or a terminal device. The electronic device may include at least one processor, which may be used to perform the method of training the classification model provided in embodiments of the present disclosure. For example, the method of training the classification model provided in embodiments of the present disclosure may be performed using a single processor, or performed in parallel using a plurality of processors.

According to embodiments of the present disclosure, by jointly training the auto-encoding module and the classification module according to the first sample data, the reconstructed sample data, the first sample classification result and the first sample classification label value of the first sample data, an error transmission and an error accumulation caused by independent training of the auto-encoding module and the classification model may be reduced. In addition, since the first sample classification label value is a supervised label value, the supervised label value of the classification module may be introduced into the auto-encoding module in the joint training process of the auto-encoding module and the classification module, and then problems of the unsupervised auto-encoding module and an easy loss of features may be effectively solved. Based on the above two aspects, an accuracy of the classification model may be improved. Due to the reduction of error transmission and error accumulation caused by independent training of the auto-encoding module and the classification model, a number of model iterations is reduced, and a training speed of the model is improved, so that a data processing capacity of an electronic device such as a processor is reduced, and a processing efficiency of the electronic device such as the processor is improved. In addition, a cost of training and optimizing subsequent models is also reduced, and then an effect of improving an internal performance of the electronic device in accordance with natural laws is obtained, thereby enhancing a core competitiveness of the electronic device.

According to embodiments of the present disclosure, the above-mentioned method of training the classification model may further include the following operations.

Raw sample data is processed based on a preprocessing method, so as to obtain the first sample data.

According to embodiments of the present disclosure, the raw sample data may include raw medical sample data. The raw medical sample data may include at least one of raw multi-omics sample data or raw medical sample image data. The preprocessing method may include at least one selected from: a missing value processing method, a data filtering method, or a data normalization method. According to embodiments of the present disclosure, due to a collection error and other reasons, the raw sample data may contain noise data and a missing value. A presence of the noise data and the missing value may affect subsequent data mining and analysis. Therefore, it is needed to perform data filtering and missing value processing on the raw sample data. In addition, there are different levels of raw sample dimension data, and a data normalization may be performed on the raw sample data.

According to embodiments of the present disclosure, the missing value may refer to data in which at least one dimension is missing. For example, in the case that the raw medical sample data is raw multi-omics sample data, the missing value may refer to data in which at least one omics data in the raw multi-omics sample data is missing.

According to embodiments of the present disclosure, the missing value processing method may include at least one of a data removal method or a data filling method. The data filling method may include at least one of a statistical value filling method or a K-nearest neighbor filling method. In a case that the raw sample data is continuous sample data, the statistical value may be at least one of an average value of the raw sample data or a median of the raw sample data. In a case that the raw sample data is discrete sample data, the statistical value may be a mode of the raw sample data. The K-nearest neighbor filling method may be used to determine a nearest neighbor feature that has a similarity greater than or equal to a predetermined similarity threshold with a feature of the missing feature (i.e., missing feature), and then complete the missing feature by weighting the nearest neighbor feature according to the similarity between the nearest neighbor feature and the missing feature. When it is determined that the raw sample data contains a missing value, the raw sample data may be removed using the data removal method.

According to embodiments of the present disclosure, the data normalization method may refer to a method of converting a value range of each level of dimension data into a same level. With the data normalization method, each level of dimension data is comparable in terms of numerical value. The data normalization method may include a zero-mean normalization method.

According to embodiments of the present disclosure, the accuracy of the first sample data is improved through obtaining the first sample data by preprocessing the raw sample data.

According to embodiments of the present disclosure, the medical sample data may include at least one of multi-omics sample data or medical sample image data.

According to embodiments of the present disclosure, the multi-omics sample data may include at least two selected from: genomics sample data, epigenomics sample data, transcriptomics sample data, proteomics sample data, metabonomics sample data, microbiome sample data, or radiomics sample data.

According to embodiments of the present disclosure, the medical sample image data may include at least one selected from: sample CT image data, sample ECT image data, sample PET image data, sample MRI image data, sample ultrasound image data, sample OCT image data, or sample radiography data.

According to embodiments of the present disclosure, the multi-omics sample data may include tumor multi-omics sample data. The classification model may be used to determine a tumor type.

According to embodiments of the present disclosure, tumor is a complex disease with a high heterogeneity at a molecular level. Tumor cells may mutate in genomics, transcriptomics, epigenomics and proteomics. For example, it may be at least one of gene mutation, gene expression abnormality, copy number variation, methylation variation, or protein modification change.

According to embodiments of the present disclosure, the multi-omics sample data may include tumor multi-omics sample data. For example, the tumor multi-omics sample data may include at least one selected from: liver cancer multi-omics sample data, lung cancer multi-omics sample data, gastric cancer multi-omics sample data, or thyroid cancer multi-omics sample data. The classification model may be used to determine a tumor type. For example, the classification model may be used to determine a liver cancer subtype classification.

According to embodiments of the present disclosure, the tumor multi-omics sample data may include at least two selected from: sample DNA methylation data, sample single nucleotide variations (SNV), sample copy number variations (CNV) data, sample gene expression data, sample clinical data, or sample protein expression profile, etc.

According to embodiments of the present disclosure, the classification model may be used to determine the tumor type, so as to provide a basis for medical research and medical diagnosis.

According to embodiments of the present disclosure, the above-mentioned method of training the classification model may further include the following operations.

A sample file set is acquired. The sample file set may include a plurality of sample files. The sample file set is parsed to obtain an attribute information corresponding to the plurality of sample files and at least one first sample dimension data. The first sample data and the sample classification label value of the first sample data are obtained according to the attribute information corresponding to the plurality of sample files. The first sample data may include at least the first sample dimension data.

According to embodiments of the present disclosure, a type of the sample file may be determined according to actual service needs and is not limited here. For example, the type of the sample file may include JSON (Java Script Object Notation). The attribute information may include a file identification, a data type, and an entity submitter identification (i.e., Entity_Submitter_ID). The entity submitter identification may include at least two identifications. For example, the entity submitter identification may include a project type identification, a sample institution source identification, a project participant identification, a sample tissue source identification, an analyte information identification, and a sequence identification of a plate in a well plate sequence. The sample institution source identification may include at least one of a university identification or a research institute identification. The sample tissue source identification may include at least one of a tumor type or a normal type. For example, in the case that the first sample data is the multi-omics sample data, the data type may include at least two selected from: DNA methylation data, single nucleotide variation, copy number variation, or gene expression data.

According to embodiments of the present disclosure, the plurality of sample files may be parsed to obtain attribute information respectively corresponding to the plurality of sample files and at least one first sample dimension data. For example, the sample file may be parsed using a file parsing tool, so as to obtain the attribute information corresponding to the sample file and at least one first sample dimension data.

According to embodiments of the present disclosure, after the attribute information of the sample file is obtained, the first sample data and the sample classification label value of the first sample data may be obtained according to the plurality of attribute information. For example, the first sample data may be obtained according to the entity submitter identification in the attribute information. The sample classification label value of the first sample data may be obtained according to the sample tissue source identification in the attribute information. Obtaining the first sample data according to the entity submitter identification in the attribute information may include: determining an entity submitter identification with a same target identification from a plurality of entity submitter identifications, and determining at least one first sample dimension data corresponding to the entity submitter identification with the same target identification as the first sample dimension data in the first sample data. The target identification may include the project participant identification and the sample tissue source identification.

According to embodiments of the present disclosure, operation S210 may include the following operations.

The first sample data is processed using at least one encoder to obtain the first sample feature data. The first sample feature data is processed using at least one decoder to obtain the reconstructed sample data.

According to embodiments of the present disclosure, the first sample data may include at least one first sample dimension data, the first sample feature data may include at least one first sample feature dimension data, and the reconstructed sample data may include at least one reconstructed sample dimension data. In a case that the auto-encoding module includes one autoencoder, the at least one first sample dimension data may be processed using the encoder to obtain the first sample feature data. The first sample feature data may be processed using the decoder to obtain the reconstructed sample data. In a case that the auto-encoding module includes a plurality of autoencoders, the first sample dimension data respectively corresponding to the plurality of encoders may be processed using the plurality of encoders, so as to obtain the first sample feature dimension data respectively corresponding to the plurality of encoders. The first sample feature data may be obtained according to the first sample feature dimension data respectively corresponding to the plurality of encoders. The first sample feature dimension data respectively corresponding to the plurality of decoders may be processed using the plurality of decoders, so as to obtain reconstructed sample dimension data respectively corresponding to the plurality of decoders. The reconstructed sample data may be obtained according to the reconstructed sample dimension data respectively corresponding to the plurality of decoders.

According to embodiments of the present disclosure, since the first sample feature data is obtained by processing the first sample data using at least one encoder included in the auto-encoding module, and the first sample classification result is obtained by processing the first sample feature data using the classification module, the classification module and the auto-encoding module may share the model parameter of the encoder in the auto-encoding module in the process of jointly training the classification module and the auto-encoding module.

According to embodiments of the present disclosure, the classification module may include at least one classifier. The first sample feature data may include at least one first sample feature dimension data.

According to embodiments of the present disclosure, operation S220 may include the following operations.

The first sample feature dimension data corresponding to the at least one classifier is processed using the at least one classifier to obtain the first sample classification result.

According to embodiments of the present disclosure, the first sample feature data may include at least one first sample feature dimension data. In the case that the classification module includes one classifier, the at least one first sample dimension data may be processed using the classifier, so as to obtain the first sample feature data. The first sample feature data may be processed using the decoder to obtain the first sample classification result. In the case that the classification module includes a plurality of classifiers, the first sample feature dimension data respectively corresponding to the plurality of classifiers may be processed using the plurality of classifiers to obtain sample classification results respectively corresponding to the plurality of classifiers. The first sample classification result may be obtained according to the sample classification results respectively corresponding to the plurality of classifiers.

According to embodiments of the present disclosure, in the case that the auto-encoding module includes one autoencoder and the classification module includes one classifier, a dependency relationship between various sample dimension data is comprehensively considered. In the case that the auto-encoding module includes a plurality of autoencoders and the classification module includes one classifier, a data structure and distribution characteristics of the first sample feature data may be effectively preserved. In the case that the auto-encoding module includes a plurality of autoencoders and the classification module includes a plurality of classifiers, it is possible to model each first sample dimension data group separately, and the distribution characteristics of each first sample dimension data group are considered.

According to embodiments of the present disclosure, the classification model may include a first attention module.

According to embodiments of the present disclosure, the above-mentioned method of training the classification model may further include the following operations.

The first sample feature data of the first sample data is processed using the first attention module, so as to obtain first weighted sample feature data.

According to embodiments of the present disclosure, operation S220 may include the following operations.

The first weighted sample feature data is processed using the classification module to obtain the first sample classification result.

According to embodiments of the present disclosure, an attention module may be used to implement an attention mechanism. The attention mechanism may be used to focus important information by a high weight, ignore non-important information by a low weight, and exchange information with other information by sharing important information, thus achieving a transmission of important information. A model structure of the attention module may be determined according to actual service needs and is not limited here. For example, the model structure of the attention module may be determined according to actual service needs, and is not limited here.

According to embodiments of the present disclosure, the first sample feature data may include at least one first sample feature dimension data. The at least one first sample feature dimension data may be processed using the first attention module to obtain first weighted sample feature dimension data corresponding to the at least one first sample feature dimension data. The first weighted sample feature data may be obtained according to the first weighted sample feature dimension data corresponding to the at least one first sample feature dimension data.

According to embodiments of the present disclosure, various first sample feature dimension data extracted by the auto-encoding module may have different importance levels to a classification task. By processing the first sample feature data using the first attention module to obtain the first weighted sample feature data before performing a classification operation, an influence of the highly important first sample feature dimension data on the classification result is improved, and the accuracy of the classification result is improved.

According to embodiments of the present disclosure, the first sample feature data may include a plurality of first sample feature dimension data.

According to embodiments of the present disclosure, the above-mentioned method of training the classification model may further include the following operations.

At least one first sample feature dimension data is determined from the plurality of first sample feature dimension data based on a feature selection method. Second sample feature data is obtained according to the at least one first sample feature dimension data.

According to embodiments of the present disclosure, operation S220 may include the following operations.

The second sample feature data is processed using the classification module to obtain the first sample classification result.

According to embodiments of the present disclosure, the feature selection method may refer to a method used to reduce a number of dimensions and a redundancy of the first sample feature dimension data. The feature selection method may include a filtering method. The filtering method may include at least one selected from: a variance threshold method, a correlation coefficient method, a chi square test method, or a mutual information method.

According to embodiments of the present disclosure, an importance evaluation strategy may be determined based on the feature selection method. At least one first sample feature dimension data may be determined from the plurality of first sample feature dimension data based on the importance evaluation strategy, so as to obtain the second sample feature data. For example, O first sample feature dimension data may be determined from J first sample feature dimension data based on the importance evaluation strategy. The second sample feature data may be obtained according to the O first sample feature dimension data. J may be an integer greater than 1. O may be an integer greater than or equal to 1 and less than J.

According to embodiments of the present disclosure, since the second sample feature data is obtained using the at least one first sample feature dimension data that is determined from a plurality of first sample feature dimension data according to the feature selection method, the dimension and redundancy of the second sample feature data are reduced. On this basis, the second sample feature data is processed using the classification module to obtain the first sample classification result, so that a generalization ability of the classification model and the accuracy of the classification result may be improved.

According to embodiments of the present disclosure, determining at least one first sample feature dimension data from the plurality of first sample feature dimension data based on the feature selection method may include the following operations.

An importance evaluation value corresponding to the plurality of first sample feature dimension data is determined based on the importance evaluation strategy, so as to obtain a plurality of importance evaluation values. The importance evaluation value may indicate an importance level of the first sample feature dimension data. The at least one sample feature dimension data may be determined from the plurality of first sample feature dimension data according to the plurality of importance evaluation values.

According to embodiments of the present disclosure, the importance evaluation value may be used to indicate the importance level of the first sample feature dimension data. A relationship between a numeric value of the importance evaluation value and the importance level may be determined according to actual service needs and is not limited here. For example, the larger the numeric value of the importance evaluation value, the greater the importance level of the first sample feature dimension data is represented: or otherwise, the less the importance level is represented. Alternatively, the smaller the numeric value of the importance evaluation value, the greater the importance level of the first sample feature dimension data is represented: or otherwise, the less the importance level is represented. A type of the importance evaluation value may be determined according to actual service needs and is not limited here. For example, the importance evaluation value may include at least one of a variance or a correlation coefficient.

According to embodiments of the present disclosure, there may be a plurality of first sample data. The first sample feature data may include respective first sample feature dimension data of a plurality of first sample feature dimensions. The importance evaluation values respectively corresponding to the plurality of first sample feature dimensions may be determined according to the plurality of first sample feature data based on the importance evaluation strategy. At least one first sample feature dimension may be determined from the plurality of first sample feature dimensions according to the importance evaluation values respectively corresponding to the plurality of first sample feature dimensions. For example, for an importance evaluation value among the plurality of importance evaluation values, when the importance evaluation value is determined to be greater than or equal to a predetermined importance evaluation threshold, the first sample feature dimension data corresponding to the importance evaluation value is determined as the first sample feature dimension data in the at least one first sample feature dimension data. Alternatively, the plurality of first sample feature dimensions may be sorted according to the plurality of importance evaluation values to obtain a sorting result. At least one first sample feature dimension may be determined from the plurality of first sample feature dimensions according to the sorting result. The sorting may be in a descending order of importance evaluation values or in an ascending order of importance evaluation values. For example, the larger the numeric value of the importance evaluation value, the greater the importance level of the first sample feature dimension data is represented. If the sorting is in an ascending order of the importance evaluation values, the first sample feature dimension data corresponding to a predetermined number of importance evaluation values ranked behind may be determined as the first sample feature dimension data in the second sample feature data.

For example, the importance evaluation value is a variance. In a case that the importance evaluation value corresponding to the first sample feature dimension is determined to be 0, it may indicate that the plurality of first sample feature data substantially have no difference in term of the first sample feature dimension. Therefore, the first sample feature dimension data corresponding to the first sample feature dimension is useless for distinguishing the sample data.

According to embodiments of the present disclosure, the classification model may include a second attention module.

According to embodiments of the present disclosure, the above-mentioned method of training the classification model may further include the following operations.

The second sample feature data is processed using the second attention module to obtain second weighted sample feature data.

According to embodiments of the present disclosure, operation S220 may include the following operations.

The second weighted sample feature data is processed using the classification module to obtain the first sample classification result.

According to embodiments of the present disclosure, the second sample feature data may include at least one first sample feature dimension data. The at least one first sample feature dimension data may be processed using the second attention module to obtain the second weighted sample feature dimension data corresponding to the at least one first sample feature dimension data. The second weighted sample feature data may be obtained according to the second weighted sample feature dimension data corresponding to the at least one first sample feature dimension data.

According to embodiments of the present disclosure, a model structure of the second attention module may be the same as or different from that of the first attention module.

According to embodiments of the present disclosure, various first sample feature dimension data may have different importance levels to the classification task. By processing the second sample feature data using the second attention module to obtain the second weighted sample feature data before performing the classification operation, an influence of the highly important first sample feature dimension data on the classification result may be improved, and the accuracy of the classification result may be improved.

According to embodiments of the present disclosure, operation S230 may include the following operations.

A first output value is obtained based on a first loss function according to the first sample data and the reconstructed sample data. A second output value is obtained based on a second loss function according to the first sample classification result and the first sample classification label value. The model parameter of the auto-encoding module and the model parameter of the classification module may be adjusted according to the first output value and the second output value.

According to embodiment of the present disclosure, the types of the first loss function and the second loss function may be determined according to actual service needs and are not limited here. For example, the second loss function may include a reconstruction loss function. The second loss function may include a cross entropy loss function.

According to embodiments of the present disclosure, the first sample data and the reconstructed sample data may be input into the first loss function to obtain the first output value. The first sample classification result and the first sample classification label value may be input into the second loss function to obtain the second output value. A fourth output value may be determined according to the first output value and the second output value. The fourth output value may be an output value corresponding to a fifth loss function. The fifth loss function may be determined according to the first loss function and the second loss function. Then the model parameter of the auto-encoding module and the model parameter of the classification module may be jointly adjusted according to the fourth output value until a second predetermined end condition is met. The second predetermined end condition may include at least one of reaching a maximum number of training rounds or a convergence of the fourth output value.

For example, the first loss function may be determined according to Equation (1).

$${L}_{1} = {\sum }_{m = 1}^{M} {\vert {x}_{m} - {z}_{m} \vert}^{2} \qquad ( 1 )$$

According to embodiments of the present disclosure, L₁ may represent the first loss function, xₘ may represent an m^{th} first sample dimension data group, zₘ may represent the reconstructed sample data corresponding to xₘ, M may represent the number of first sample dimension data groups, where M may be an integer greater than or equal to 2, m∈{1, 2, . . . , M−1, M}.

For example, the first loss function may be determined according to Equation (2).

$${L}_{1} = {\vert x - z \vert}^{2} \qquad ( 2 )$$

According to embodiments of the present disclosure, L₁ may represent the first loss function, x may represent the first sample data, and z may represent the reconstructed sample data.

For example, the second loss function may be determined according to Equation (3).

$${L}_{2} = ( - \frac{1}{N} {\sum }_{n = 1}^{N} {\sum }_{k = 1}^{K} {t}_{nk} log {y}_{nk} ) \qquad ( 3 )$$

According to embodiments of the present disclosure, L₂ may represent the second loss function, yₙₖ may represent a first sample classification probability value corresponding to a k^{th} category for an n^{th} first sample data, tₙₖ may represent the first sample classification label value corresponding to the k^{th} category for the n^{th} first sample data, that is, tₙₖ may represent whether the n^{th} first sample data belongs to the k^{th} category. tₙₖ=1 may represent that the n^{th} first sample data belongs to the k^{th} category, and tₙₖ=0 may represent that the n^{th} first sample data does not belong to the k^{th} category. N may represent the number of the first sample data, and K may represent the number of categories. N may be an integer greater than or equal to 1, and K may be an integer greater than or equal to 1. n∈{1,2, . . . , N−1, N}, k∈{1,2, . . . , K−1, K}.

For example, the fifth loss function may be determined according to Equation (4).

$${L}_{5} = {L}_{1} + {L}_{2} \qquad ( 4 )$$

According to embodiments of the present disclosure, L₅ may represent the fifth loss function.

According to embodiments of the present disclosure, obtaining the second output value based on the second loss function according to the first sample classification result and the first sample classification label value may include the following operations.

The second output value is obtained based on a third loss function according to the first sample classification result and the first sample classification label value. The third loss function may be determined according to the second loss function and a first penalty term.

According to embodiments of the present disclosure, the first penalty term may be used to achieve a feature selection of the first sample feature dimension data during the training process of the classification model.

For example, the third loss function may be determined according to Equation (5).

$${L}_{3} = {L}_{2} + {λ}_{1} {Ω}_{1} ( w ) \qquad ( 5 )$$

According to embodiments of the present disclosure, Ω₁(w) may represent the first penalty term, λ₁ may represent a first hyper-parameter, where λ₁ may be a number greater than or equal to 0, and w may represent a model parameter of a deep learning model. Ω₁(w) may be an L1 penalty term. For example, Ω₁(w)=∥w∥₁, where ∥ ∥₁ may represent an L1 norm.

According to embodiments of the present disclosure, the third loss function may be determined according to the second loss function and the first penalty term, and the first penalty term may be used to achieve the feature selection of the first sample feature dimension data in the training process of the classification model, so that the dimension and redundancy of the first sample feature data may be reduced. On this basis, the first sample feature data is processed using the classification module to obtain the first sample classification result, so that the generalization ability of the classification model and the accuracy of the classification result may be improved.

According to embodiments of the present disclosure, the above-mentioned method of training the classification model may further include the following operations.

Second sample data is processed using the encoder of the classification model, so as to obtain third sample feature data. The classification module of the classification model is optimized using the third sample feature data.

According to embodiments of the present disclosure, after completing the joint training of the auto-encoding module and the classification module to obtain the classification model, the classification module of the classification model may be further optimized using the second sample data while keeping the model parameter of the encoder of the classification model unchanged.

According to embodiments of the present disclosure, the accuracy of the classification result of the classification model may be improved by optimizing the classification module of the classification model using the second sample data.

According to embodiments of the present disclosure, the third sample feature data may include a plurality of second sample feature dimension data.

According to embodiments of the present disclosure, optimizing the classification module of the classification model using the third sample feature data may include repeatedly performing the following operations until a performance test result of the classification module meets a predetermined performance condition.

A model performance of the classification module is tested using candidate sample feature data, so as to obtain the performance test result. When it is determined that the performance test result does not meet the predetermined performance condition, at least one second sample feature dimension data is determined from the plurality of second sample feature dimension data to obtain new candidate sample feature data.

According to embodiments of the present disclosure, the model performance may be represented by a model performance evaluation value. The performance test result includes the model performance evaluation value. The model performance evaluation value may include at least one selected from: precision, recall rate, accuracy, error rate, or F-function value. The predetermined performance condition may refer to that the performance evaluation value is greater than or equal to a predetermined performance evaluation threshold. The predetermined performance evaluation threshold may be determined according to actual service needs and is not limited here.

According to embodiments of the present disclosure, the second sample feature data may include a plurality of second sample feature dimension data. At least one second sample feature dimension data may be determined from the plurality of second sample feature dimension data based on a search strategy, so as to obtain candidate sample data. The model performance of the classification module may be tested using the candidate sample data to obtain the performance test result. For example, the candidate sample data may be processed using the classification module to obtain a third sample classification result. The performance test result may be determined according to the third sample classification result. It is determined whether the performance test result meets the predetermined performance condition. When it is determined that the performance test result meets the predetermined performance condition, an optimization operation for the classification model may end. When it is determined that the performance test result does not meet the predetermined performance condition, at least one second sample feature dimension data may be determined from the plurality of second sample feature dimension data based on the search strategy, so as to obtain new candidate sample data. The model performance of the classification module may be tested using the new candidate sample data to obtain the performance test result. The above operations may be repeatedly performed until the performance test result meets the predetermined performance condition.

According to embodiments of the present disclosure, the search strategy may include a complete search strategy, a heuristic search strategy, or a recursive feature elimination strategy. The performance test may be performed on the trained classification module using the candidate sample data, so as to obtain the performance test result.

According to embodiments of the present disclosure, the performance test result is obtained by repeatedly testing the model performance of the classification module using the candidate sample feature data. When it is determined that the performance test result does not meet the predetermined performance condition, the operation of determining at least one second sample feature dimension data from the plurality of second sample feature dimension data to obtain new candidate sample feature data is repeatedly performed until the performance test result of the classification module meets the predetermined performance condition, so that the accuracy of the classification result of the classification model may be improved.

According to embodiments of the present disclosure, optimizing the classification module of the classification model using the third sample feature data may include the following operations.

The third sample feature data is processed using the classification module to obtain a second sample classification result. A third output value is obtained based on a fourth loss function according to a second sample classification label value of the second sample data and the second sample classification result. The fourth loss function may be determined according to the second loss function and a second penalty term. The model parameter of the classification module is adjusted according to the third output value.

According to embodiments of the present disclosure, the third sample feature data may be input into the classification module to obtain the second sample classification result. The second sample classification result and the second sample classification label value may be input into the fourth loss function to obtain the third output value. The model parameter of the classification module may be adjusted according to the third output value until a third predetermined end condition is met. The third predetermined end condition may include at least one of reaching the maximum number of training rounds and a convergence of the third output value.

According to embodiments of the present disclosure, the second penalty term may be used to achieve a feature selection of the second sample feature dimension data in the optimization process of the classification module.

For example, the fourth loss function may be determined according to Equation (6).

$${L}_{4} = {L}_{2} + {λ}_{2} {Ω}_{2} ( {w}^{′} ) \qquad ( 6 )$$

According to embodiments of the present disclosure, Ω₂(w′) may represent the second penalty term, λ₂ may represent a second hyper-parameter, where λ₂ may be a number greater than or equal to 0, and w′ may represent the model parameter of the classification module. Ω₂(w′) may be an L1 penalty term. For example, Ω₂ (w′)=∥w′∥₁, where ∥ ∥₁ may represent an L1 norm.

According to embodiments of the present disclosure, the fourth loss function may be determined according to the second loss function and the second penalty term, and the second penalty term may be used to achieve the feature selection of the second sample feature dimension data in the optimization process of the classification module, so that the dimension and redundancy of the third sample feature data may be reduced. On this basis, the third sample feature data is processed using the classification module to obtain the second sample classification result, so that the generalization ability of the classification model and the accuracy of the classification result may be improved.

According to embodiments of the present disclosure, the classification model may include a third attention module.

According to embodiments of the present disclosure, the above-mentioned method of training the classification model may further include the following operations.

The third sample feature data is processed using the third attention module to obtain third weighted sample feature data.

According to embodiments of the present disclosure, optimizing the classification module of the classification model using the third sample feature data may include the following operations.

The classification module is optimized using the third weighted sample feature data.

According to embodiments of the present disclosure, the third sample feature data may be input into the third attention module to obtain the third weighted sample feature data. The third weighted sample feature data may include a plurality of second weighted sample feature dimension data. Optimizing the classification module using the third weighted sample data may include repeatedly performing the following operations until the performance test result of the classification module meets a predetermined performance condition: testing the model performance of the classification module using candidate weighted sample feature data to obtain a performance test result; when it is determined that the performance test result does not meet the predetermined performance condition, selecting at least one second weighted sample feature dimension data from the plurality of second weighted sample feature dimension data to obtain new candidate weighted sample feature data.

According to embodiments of the present disclosure, optimizing the classification module using the third weighted sample feature data may include: processing the third weighted sample feature data using the classification module to obtain the third sample classification result: obtaining a fifth output value based on a fourth loss function according to a third sample classification label value of the third sample data and the third sample classification result, where the fourth loss function may be determined according to the second loss function and the second penalty term; adjusting the model parameter of the classification module according to the fifth output value.

According to embodiments of the present disclosure, various second sample feature dimension data may have different importance levels to the classification task. By processing the third sample feature data using the third attention module to obtain the third weighted sample feature data before performing the classification operation, the influence of the highly important second sample feature dimension data on the classification result may be increased, and the accuracy of the classification result may be improved.

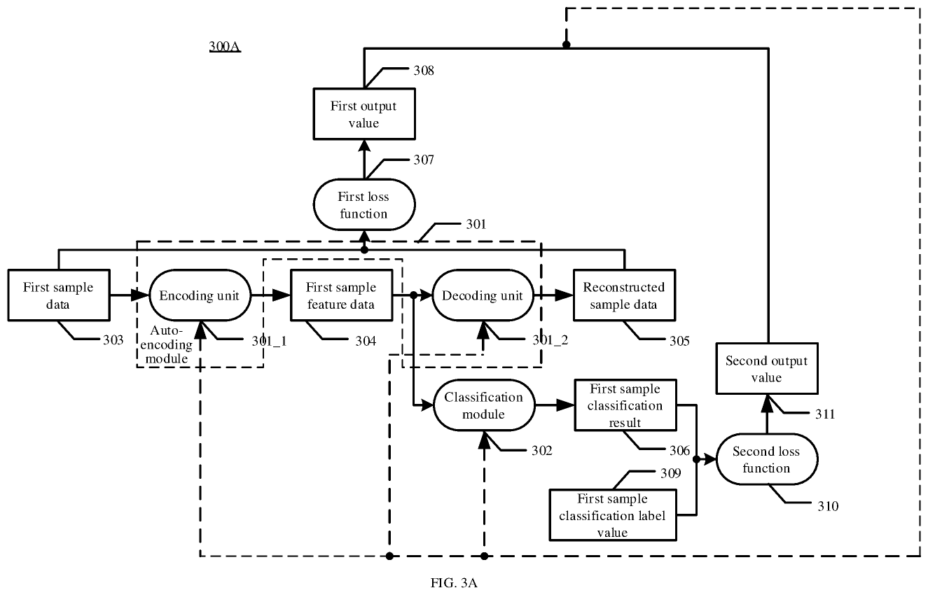

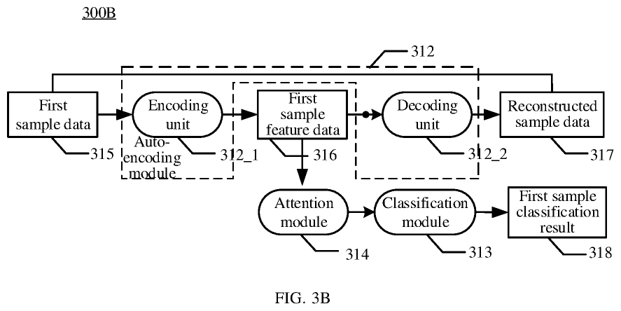

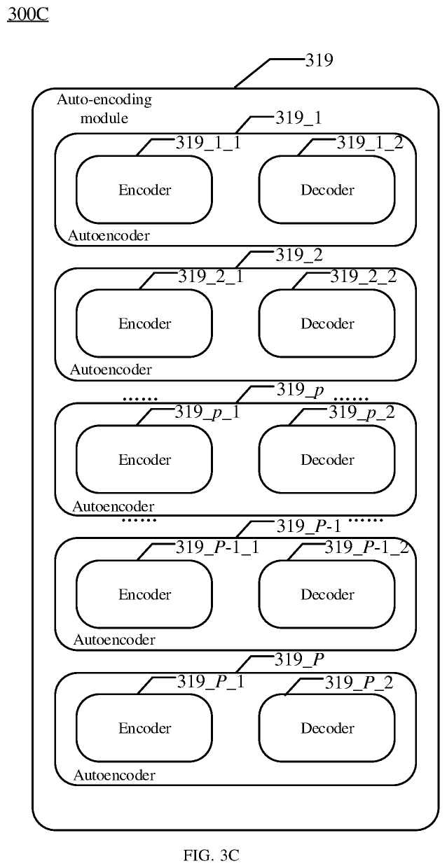

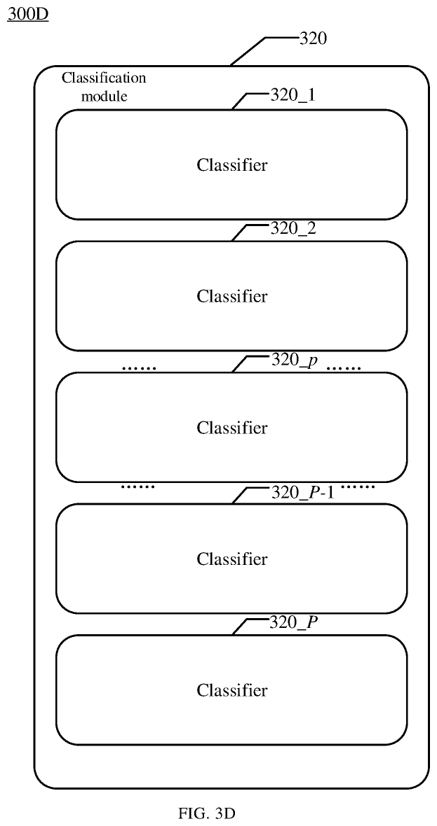

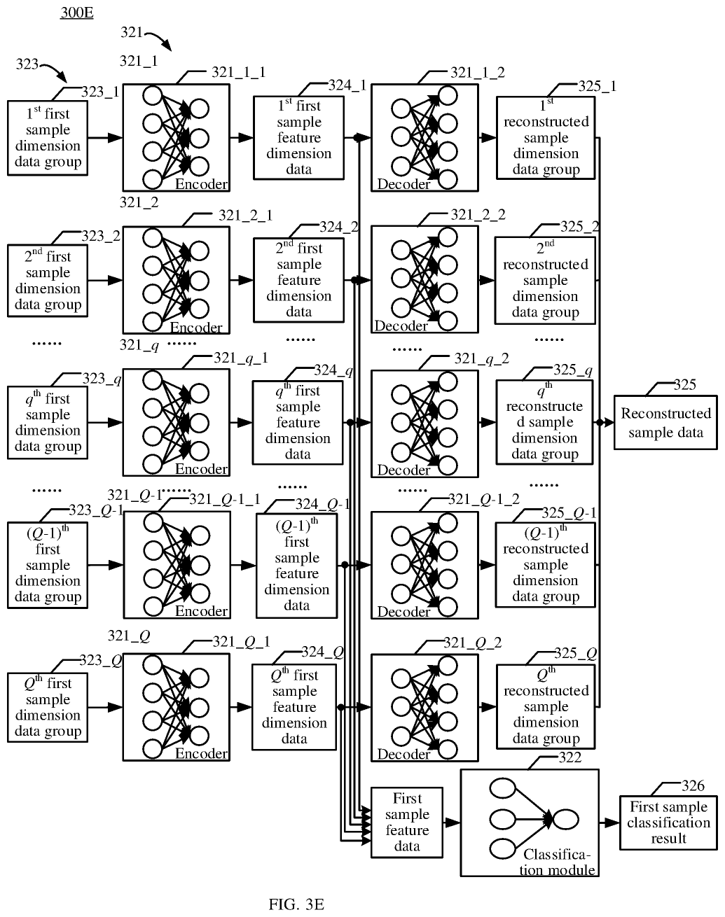

The method of training the classification model according to embodiments of the present disclosure will be further described below with reference to FIG. 3A to FIG. 3F in conjunction with specific embodiments.

FIG. 3A schematically shows an example schematic diagram of the training process of the classification model according to embodiments of the present disclosure.

As shown in FIG. 3A, in 300A, the deep learning model may include an auto-encoding module 301 and a classification module 302. The auto-encoding module 301 may include an encoding unit 301_1 and a decoding unit 301_2. The encoding unit 301_1 may include at least one encoder. The decoding unit 301_2 may include at least one decoder. The autoencoder may include an encoder and a decoder.

First sample data 303 may be input into the encoding unit 301_1 to obtain first sample feature data 304. The first sample feature data 304 may be input into the decoding unit 301_2 to obtain reconstructed sample data 305. The first sample feature data 304 may be input into the classification module 302 to obtain a first sample classification result 306. The first sample data 303 and the reconstructed sample data 305 may be input into a first loss function 307 to obtain a first output value 308. The first sample classification result 306 and a first sample classification label value 309 of the first sample data 303 may be input into a second loss function 310 to obtain a second output value 311. A model parameter of the auto-encoding module 301 and a model parameter of the classification module 302 may be adjusted according to the first output value 308 and the second output value 309.

FIG. 3B schematically shows an example schematic diagram of the training process of the classification model according to other embodiments of the present disclosure.

As shown in FIG. 3B, in 300B, the deep learning model may include an auto-encoding module 312, a classification module 313, and an attention module 314. The auto-encoding module 312 may include an encoding unit 312_1 and a decoding unit 312_2. The encoding unit 312_1 may include at least one encoder. The decoding unit 312_2 may include at least one decoder. The autoencoder may include an encoder and a decoder. The attention module 314 may be the first attention module, the second attention module or the third attention module described in embodiments of the present disclosure.

First sample data 315 may be input into the encoding unit 312_1 to obtain first sample feature data 316. The first sample feature data 316 may be input into the decoding unit 312_2 to obtain reconstructed sample data 317. The first sample feature data 315 is input into the attention module 314 to obtain weighted sample feature data. The weighted sample feature data may be the first weighted sample feature data and the second weighted sample feature data described in embodiments of the present disclosure. The weighted sample feature data may be input into the classification module 313 to obtain a first sample classification result 318. The first sample data 315 and the reconstructed sample data 317 may be input into the first loss function to obtain the first output value. The first sample classification result 318 and a first sample classification label value of the first sample data 315 may be input into the second loss function to obtain the second output value. The model parameters of the auto-encoding module 312, the classification module 313 and the attention module 314 may be adjusted according to the first output value and the second output value.

FIG. 3C schematically shows an example schematic diagram of a model structure of the auto-encoding module according to embodiments of the present disclosure.

As shown in FIG. 3C, in 300C, an auto-encoding module 319 may include P autoencoders, such as autoencoder 319_1, autoencoder 319_2, . . . , autoencoder 319_p, . . . , autoencoder 319_P−1, and autoencoder 319_P. p∈{1, 2, . . . , P−1, P}, where P may be an integer greater than or equal to 1.

The autoencoder 319_1 may include encoder 319_1_1 and decoder 319_1_2. The autoencoder 319_2 may include encoder 319_2_1 and decoder 319_2_2. The autoencoder 319_p may include encoder 319_p_1 and decoder 319_p_2. The autoencoder 319_P−1 may include encoder 319_P−1_1 and decoder 319_P−1_2. The autoencoder 319_P may include encoder 319_P_1 and decoder 319_P_2. The encoding unit may include encoder 319_1_1, encoder 319_2_1, . . . , encoder 319_p_1, . . . , encoder 319_P−1_1, and encoder 319_P_1. The decoding unit may include decoder 319_1_2, decoder 319_2_2, . . . , decoder 319_p_2, . . . , decoder 319_P−1_2, and decoder 319_P_2.

FIG. 3D schematically shows an example schematic diagram of the model structure of the classification module according to embodiments of the present disclosure.

As shown in FIG. 3D, in 300D, a classification module 320 may include P classifiers, such as classifier 320_1, classifier 320_2, classifier 320_p, . . . , classifier 320_P−1, and classifier 320_P. p∈{1, 2, . . . , P−1, P}, where P may be an integer greater than or equal to 1.

FIG. 3E schematically shows an example schematic diagram of the training process of the classification model according to other embodiments of the present disclosure.

As shown in FIG. 3E, in 300E, the deep learning model may include an auto-encoding module 321 and a classification module 322. The auto-encoding module 321 may include Q autoencoders, such as autoencoder 321_1, autoencoder 321_2, . . . , autoencoder 321_q, . . . autoencoder 321_Q−1, and autoencoder 321_Q. q∈{1, 2, . . . , Q−1, Q}, where Q may be an integer greater than or equal to 1.

The autoencoder 321_1 may include encoder 321_1_1 and decoder 321_1_2. The autoencoder 321_2 may include encoder 321_2_1 and decoder 321_2_2. The autoencoder 321_q may include encoder 321_q_1 and decoder 321_q_2. The autoencoder 321_Q−1 may include encoder 321_Q−1_1 and decoder 321_Q−1_2. The autoencoder 321_Q may include encoder 321_Q_1 and decoder 321_Q_2.

First sample data 323 may include Q first sample dimension data groups, such as 1^{st} first sample dimension data group 323_1, 2^{nd} first sample dimension data group 323_2, . . . , q^{th} first sample dimension data group 323_q, . . . , (Q−1)^{th} first sample dimension data group 323_Q−1, and Q^{th} first sample dimension data group 323_Q.

First sample feature data 324 may include Q first sample feature dimension data, such as 1^{st} first sample feature dimension data 324_1, 2^{nd} first sample feature dimension data 324_2, . . . , q^{th} first sample feature dimension data 324_q, . . . , (Q−1)^{th} first sample feature dimension data 324_Q−1, and Q^{th} first sample feature dimension data 324_Q.

The q^{th} first sample dimension data group 323_q may be input into the encoder 321_q_1 to obtain the q^{th} first sample feature dimension data 324_q. The q^{th} first sample feature dimension data 324_q may be input into the decoder 321_q_2 to obtain q^{th} reconstructed sample dimension data group 325_q.

Reconstructed sample data 325 may be obtained according to 1^{st} reconstructed sample dimension data group 325_1, 2^{nd} reconstructed sample dimension data group 325_2, . . . , q^{th} reconstructed sample dimension data group 325_q, . . . , (Q−1)^{th} reconstructed sample dimension data group 325_Q−1, and Q^{th} reconstructed sample dimension data group 325_Q.

The 1^{st} first sample feature dimension data 324_1, the 2^{nd} first sample feature dimension data 324_2, . . . , the q^{th} first sample feature dimension data 324_q, . . . , the (Q−1)^{th} first sample feature dimension data 324_Q−1 and the Q^{th} first sample feature dimension data 324_Q may be input into the classification module 322 to obtain a first sample classification result 326.

FIG. 3F schematically shows an example schematic diagram of the training process of the classification model according to other embodiments of the present disclosure.

As shown in FIG. 3F, in 300F, the deep learning model may include an auto-encoding module 327 and a classification module 328. The auto-encoding module 327 may include Q autoencoders, such as autoencoder 327_1, autoencoder 327_2, . . . , autoencoder 327_q, . . . , autoencoder 327_Q−1, and autoencoder 327_Q. The classification module 328 may include Q classifiers, such as classifier 328_1, classifier 328_2, . . . , classifier 328_q, . . . , classifier 328_Q−1, and classifier 328_Q. q∈{1, 2, . . . , Q−1, Q}, where Q may be an integer greater than or equal to 1.

The autoencoder 327_1 may include encoder 327_1_1 and decoder 327_1_2. The autoencoder 327_2 may include encoder 327_2_1 and decoder 327_2_2. The autoencoder 327_q may include encoder 327_q_1 and decoder 327_q_2. The autoencoder 327_Q−1 may include encoder 327_Q−1_1 and decoder 327_Q−1_2. The autoencoder 327_Q may include encoder 327_Q_1 and decoder 327_Q_2.

First sample data 329 may include Q first sample dimension data groups, such as 1^{st} first sample dimension data group 329_1, 2^{nd} first sample dimension data group 329_2, . . . , q^{th} first sample dimension data group 329_q, . . . , (Q−1)^{th} first sample dimension data group 329_Q−1, and Q^{th} first sample dimension data group 329_Q.

First sample feature data 330 may include Q first sample feature dimension data, such as 1^{st} first sample feature dimension data 330_1, 2^{nd} first sample feature dimension data 330_2, . . . , q^{th} first sample feature dimension data 330_q, . . . , (Q−1)^{th} first sample feature dimension data 330_Q−1, and Q^{th} first sample feature dimension data 330_Q.

The q^{th} first sample dimension data group 329_q may be input into the encoder 327_q_1 to obtain the q^{th} first sample feature dimension data 330_q. The q^{th} first sample feature dimension data 330_q may be input into the decoder 327_q_2 to obtain q^{th} reconstructed sample dimension data group 331_q.

The q^{th} first sample feature dimension data 330_q may be input into the classifier 328_q to obtain q^{th} first sample classification probability value 332_q.

Reconstructed sample data 331 may be obtained according to 1^{st} reconstructed sample dimension data group 331_1, 2^{nd} reconstructed sample dimension data group 331_2, . . . , q^{th} reconstructed sample dimension data group 331_q, . . . , (Q−1)^{th} reconstructed sample dimension data group 331_Q−1, and Q^{th} reconstructed sample dimension data group 331_Q.

A first sample classification result 332 may be obtained according to 1^{st} first sample classification probability value 332_1, 2^{nd} first sample classification probability value 332_2, . . . , q^{th} first sample classification probability value 332_1, . . . , (Q−1)^{th} first sample classification probability value 332_Q−1, and Q^{th} first sample classification probability value 332_Q.

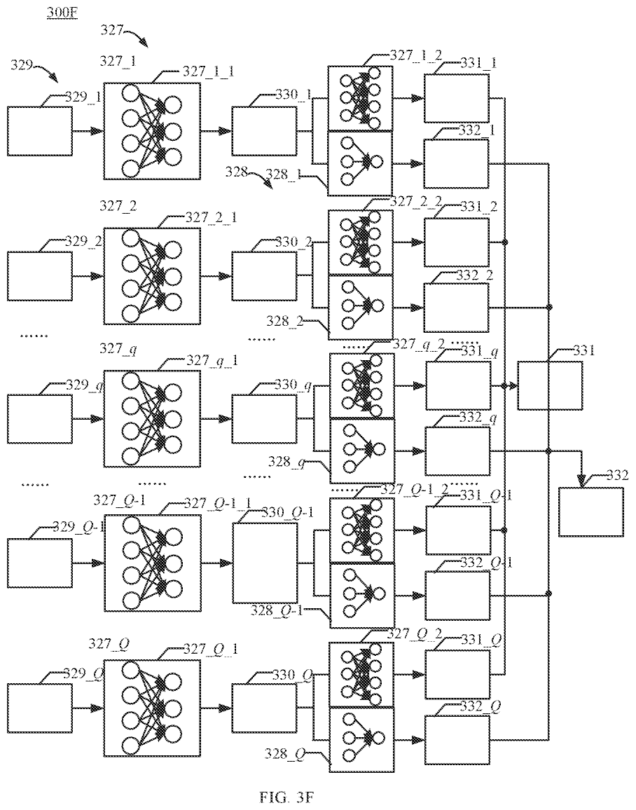

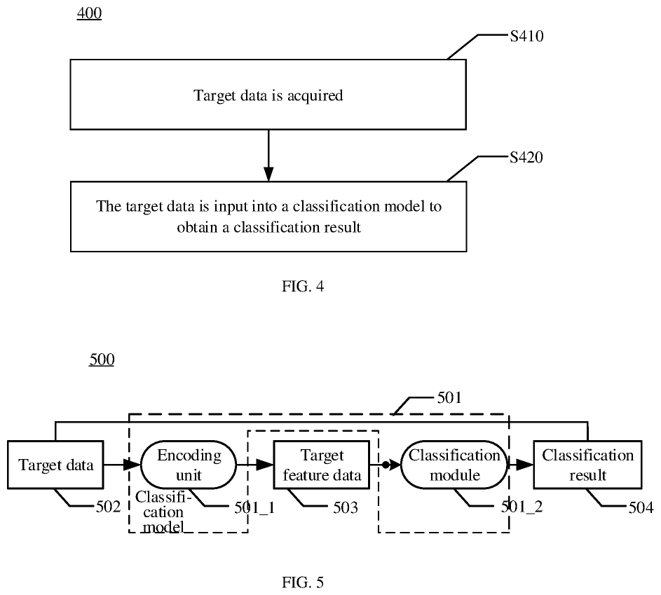

FIG. 4 schematically shows a flowchart of a classification method according to embodiments of the present disclosure.

As shown in FIG. 4, a method 400 may include operations S410 to S420.

In operation S410, target data is acquired. The target data may include medical target data.

In operation S420, the target data is input into a classification model to obtain a classification result.

According to embodiments of the present disclosure, the classification model may be trained using the method of training the classification model described in embodiments of the present disclosure. For example, the classification model may include a classification module and an encoder of an auto-encoding module. Alternatively, the classification model may include an encoder of an auto-encoding module, an attention module, and a classification module. The attention module may include the first attention module, the second attention module, or the third attention module.

According to embodiments of the present disclosure, the medical target data may include at least one of multi-omics target data or medical target image data.

FIG. 5 schematically shows an example schematic diagram of a classification process according to embodiments of the present disclosure.

As shown in FIG. 5, in 500, a classification model 501 may include an encoding unit 501_1 and a classification module 501_2.

The target data may be input into the encoding unit 501_1 to obtain target feature data 503. The target feature data 503 may be input into the classification module 501_2 to obtain a classification result 504.

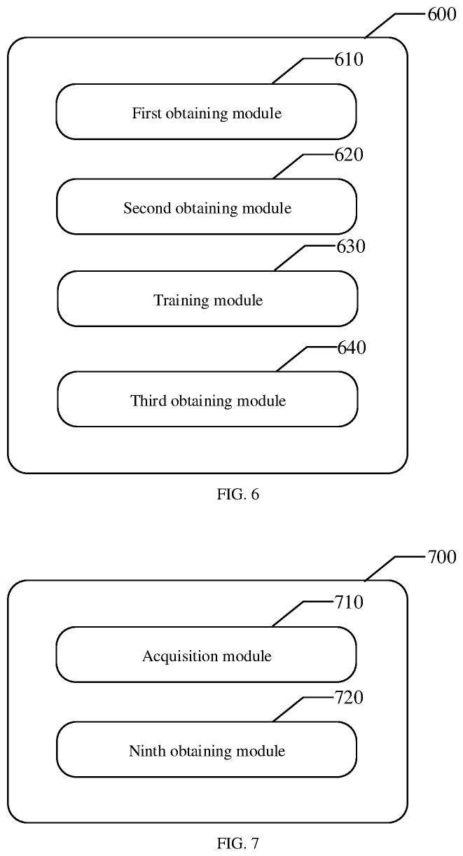

FIG. 6 schematically shows a block diagram of an apparatus of training a classification model according to embodiments of the present disclosure.

As shown in FIG. 6, an apparatus 600 of training a classification model may include a first obtaining module 610, a second obtaining module 620, a training module 630, and a third obtaining module 640.

The first obtaining module 610 is used to process first sample data by using an auto-encoding module, so as to obtain reconstructed sample data. The auto-encoding module includes at least one autoencoder. The autoencoder includes an encoder and a decoder. The first sample data includes medical sample data.

The second obtaining module 620 is used to process first sample feature data of the first sample data by using a classification module, so as to obtain a first sample classification result.

The training module 630 is used to jointly train the auto-encoding module and the classification module according to the first sample data, the reconstructed sample data, the first sample classification result, and a first sample classification label value of the first sample data.

The third obtaining module 640 is used to obtain the classification model according to the trained encoder and the trained classification module.

According to embodiments of the present disclosure, the first obtaining module 610 may include a first obtaining sub-module and a second obtaining sub-module.

The first obtaining sub-module is used to process the first sample data by using at least one encoder, so as to obtain first sample feature data.

The second obtaining sub-module is used to process the first sample feature data by using at least one decoder, so as to obtain the reconstructed sample data.

According to embodiments of the present disclosure, the classification module includes at least one classifier. The first sample feature data includes at least one first sample feature dimension data.

According to embodiments of the present disclosure, the second obtaining module 620 may include a third obtaining sub-module.

The third obtaining sub-module is used to process the first sample feature dimension data corresponding to the at least one classifier by using the at least one classifier, so as to obtain the first sample classification result.

According to embodiments of the present disclosure, the classification model includes a first attention module.

According to embodiments of the present disclosure, the apparatus 600 of training the classification model may further include a fourth obtaining module.

The fourth obtaining module is used to process the first sample feature data of the first sample data by using the first attention module, so as to obtain first weighted sample feature data.

According to embodiments of the present disclosure, the second obtaining module 620 may include a fourth obtaining sub-module.

The fourth obtaining sub-module is used to process the first weighted sample feature data by using the classification module, so as to obtain the first sample classification result.

According to embodiments of the present disclosure, the first sample feature data includes a plurality of first sample feature dimension data.

According to embodiments of the present disclosure, the apparatus 600 of training the classification model may further include a determination module and a fifth obtaining module.

The determination module is used to determine at least one first sample feature dimension data from the plurality of first sample feature dimension data based on a feature selection method.

The fifth obtaining module is used to obtain second sample feature data based on the at least one first sample feature dimension data.

According to embodiments of the present disclosure, the second obtaining module 620 may include a fifth obtaining sub-module.

The fifth obtaining sub-module is used to process the second sample feature data by using the classification module, so as to obtain the first sample classification result.

According to embodiments of the present disclosure, the determination module may include a first determination sub-module and a second determination sub-module.

The first determination sub-module is used to determine, based on an importance evaluation strategy, an importance evaluation value corresponding to the plurality of first sample feature dimension data, so as to obtain a plurality of importance evaluation values. The importance evaluation value indicates an importance of the first sample feature dimension data.

The second determination sub-module is used to determine the at least one sample feature dimension data from the plurality of first sample feature dimension data according to the plurality of importance evaluation values.

According to embodiments of the present disclosure, the classification model includes a second attention module.

According to embodiments of the present disclosure, the apparatus of training the classification model may further include a sixth obtaining module.

The sixth obtaining module is used to process the second sample feature data by using the second attention module, so as to obtain second weighted sample feature data.

According to embodiments of the present disclosure, the fifth obtaining sub-module may include a first obtaining unit.

The first obtaining unit is used to process the second weighted sample feature data by using the classification module, so as to obtain the first sample classification result.

According to embodiments of the present disclosure, the training module 630 may include a sixth obtaining sub-module, a seventh obtaining sub-module, and a first adjustment sub-module.

The sixth obtaining sub-module is used to obtain a first output value according to the first sample data and the reconstructed sample data based on a first loss function.

The seventh obtaining sub-module is used to obtain a second output value according to the first sample classification result and the first sample classification label value based on a second loss function.

The first adjustment sub-module is used to adjust a model parameter of the auto-encoding module and a model parameter of the classification module according to the first output value and the second output value.

According to embodiments of the present disclosure, the seventh obtaining sub-module may include a second obtaining unit.

The second obtaining unit is used to obtain the second output value according to the first sample classification result and the first sample classification label value based on a third loss function. The third loss function is determined according to the second loss function and a first penalty term.

According to embodiments of the present disclosure, the apparatus of training the classification model may further include a seventh obtaining module and an optimization module.

The seventh obtaining module is used to process second sample data by using an encoder of the classification model, so as to obtain third sample feature data.

The optimization module is used to optimize the classification module of the classification model by using the third sample feature data.

According to embodiments of the present disclosure, the third sample feature data includes a plurality of second sample feature dimension data.

According to embodiments of the present disclosure, the optimizing the classification module of the classification model by using the third sample feature data includes repeatedly performing the following operations until a performance test result of the classification module meets a predetermined performance condition:

testing a model performance of the classification module by using candidate sample feature data, so as to obtain the performance test result; and

determining, in response to determining that the performance test result does not meet the predetermined performance condition, at least one second sample feature dimension data from the plurality of second sample feature dimension data, so as to obtain new candidate sample feature data.

According to embodiments of the present disclosure, the optimization module may include an eighth obtaining sub-module, a ninth obtaining sub-module, and a second adjustment sub-module.

The eighth obtaining sub-module is used to process the third sample feature data by using the classification module, so as to obtain a second sample classification result.

The ninth obtaining sub-module is used to obtain a third output value according to the second sample classification result and a second sample classification label value of the second sample data based on a fourth loss function. The fourth loss function is determined according to the second loss function and a second penalty term.

The second adjustment sub-module is used to adjust a model parameter of the classification module according to the third output value.

According to embodiments of the present disclosure, the classification model includes a third attention module.

According to embodiments of the present disclosure, the apparatus 600 of training the classification model may further include an eighth obtaining module.

The eighth obtaining module is used to process the third sample feature data by using the third attention module, so as to obtain third weighted sample feature data.

According to embodiments of the present disclosure, the optimization module may include an optimization sub-module.

The optimization sub-module is used to optimize the classification module by using the third weighted sample feature data.

According to embodiments of the present disclosure, the medical sample data may include at least one of multi-omics sample data or medical sample image data.

According to embodiments of the present disclosure, the multi-omics sample data may include tumor multi-omics sample data, and the classification model is used to determine a type of tumor.

FIG. 7 schematically shows a block diagram of a classification apparatus according to embodiments of the present disclosure.

As shown in FIG. 7, a classification apparatus 700 may include an acquisition module 710 and a ninth obtaining module 720.

The acquisition module 710 is used to acquire target data. The target data includes medical target data.

The ninth obtaining module 720 is used to input the target data into a classification model to obtain a classification result.

According to embodiments of the present disclosure, the classification model is trained using the apparatus of training the classification model provided in embodiments of the present disclosure.

According to embodiments of the present disclosure, the medical target data may include at least one of multi-omics target data or medical target image data.

Any number of the modules, sub-modules and units according to embodiments of the present disclosure, or at least part of functions of any number of them may be implemented in one module. Any one or more of the modules, sub-modules and units according to embodiments of the present disclosure may be split into a plurality of modules for implementation. Any one or more of the modules, sub-modules and units according to embodiments of the present disclosure may be implemented at least partially as a hardware circuit, such as a field programmable gate array (FPGA), a programmable logic array (PLA), a system on a chip, a system on a substrate, a system on a package, an Application Specific Integrated Circuit (ASIC), or may be implemented by hardware or firmware in any other reasonable manner of integrating or encapsulating the circuit, or may be implemented by any one of three implementation modes of software, hardware and firmware or an appropriate combination thereof. Alternatively, one or more of the modules, sub-modules and units according to embodiments of the present disclosure may be at least partially implemented as a computer program module that, when executed, performs the corresponding functions.

For example, any number of the first obtaining module 610, the second obtaining module 620, the training module 630 and the third obtaining module 640, or the acquisition module 710 and the ninth obtaining module 720 may be combined into one module/unit for implementation, or any one of the modules/units may be divided into a plurality of modules/units. Alternatively, at least part of the functions of one or more of these modules/units may be combined with at least part of the functions of other modules/units and implemented in one module/unit. According to embodiments of the present disclosure, at least one of the first obtaining module 610, the second obtaining module 620, the training module 630 and the third obtaining module 640, or the acquisition module 710 and the ninth obtaining module 720 may be implemented at least partially as a hardware circuit, such as a field programmable gate array (FPGA), a programmable logic array (PLA), a system on a chip, a system on a substrate, a system on a package, an Application Specific Integrated Circuit (ASIC), or may be implemented by hardware or firmware in any other reasonable manner of integrating or encapsulating the circuit, or may be implemented by any one of the three implementation modes of software, hardware and firmware or an appropriate combination thereof. Alternatively, at least one of the first obtaining module 610, the second obtaining module 620, the training module 630 and the third obtaining module 640, or the acquisition module 710 and the ninth obtaining module 720 may be at least partially implemented as a computer program module that may perform corresponding functions when executed.

It should be noted that a part for the apparatus of training the classification model in embodiments of the present disclosure corresponds to a part for the method of training the classification model in embodiments of the present disclosure. A part for the classification apparatus in embodiments of the present disclosure corresponds to a part for the classification method in embodiments of the present disclosure. For the descriptions of the classification apparatus and the apparatus of training the classification model, reference may be made to the classification method and the method of training the classification model, and details are not be repeated here.

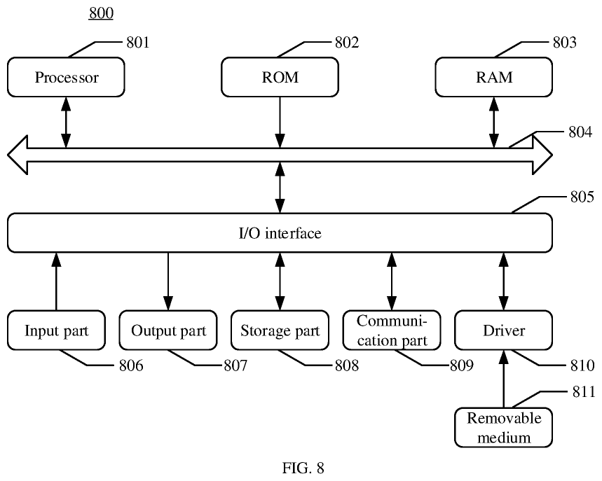

FIG. 8 schematically shows a block diagram of an electronic device suitable for implementing the method of training the classification model and the classification method according to embodiments of the present disclosure. The electronic device shown in FIG. 8 is merely an example, and should not bring any limitation to functions and scopes of use of embodiments of the present disclosure.

As shown in FIG. 8, an electronic device 800 according to embodiments of the present disclosure includes a processor 801, which may execute various appropriate actions and processing according to the program stored in a read only memory (ROM) 802 or the program loaded into a random access memory (RAM) 803 from a storage part 808. The processor 801 may, for example, include a general-purpose microprocessor (for example, CPU), an instruction set processor and/or a related chipset and/or a special-purpose microprocessor (for example, an application specific integrated circuit (ASIC)), and the like. The processor 801 may further include an on-board memory for caching purposes. The processor 801 may include a single processing unit or multiple processing units for executing different actions of the method flow according to embodiments of the present disclosure.

Various programs and data required for the operation of the device 800 are stored in the RAM 803. The processor 801, the ROM 802 and the RAM 803 are connected to each other through a bus 804. The processor 801 executes various operations of the method flow according to embodiments of the present disclosure by executing the programs in the ROM 802 and/or the RAM 803. It should be noted that the program may also be stored in one or more memories other than the ROM 802 and the RAM 803. The processor 801 may also execute various operations of the method flow according to embodiments of the present disclosure by executing the programs stored in the one or more memories.

According to embodiments of the present disclosure, the electronic device 800 may further include an input/output (I/O) interface 805 which is also connected to the bus 804. The device 800 may further include one or more of the following components connected to the I/O interface 805: an input part 806 including a keyboard, a mouse, etc.; an output part 807 including a cathode ray tube (CRT), a liquid crystal display (LCD), etc. and a speaker, etc.; a storage part 808 including a hard disk, etc.; and a communication part 809 including a network interface card such as a LAN card, a modem, and the like. The communication part 809 performs communication processing via a network such as the Internet. A drive 810 is also connected to the I/O interface 805 as required. A removable medium 811, such as a magnetic disk, an optical disk, a magneto-optical disk, a semiconductor memory, and the like, is installed on the drive 810 as required, so that the computer program read therefrom is installed into the storage part 808 as needed.

The method flow according to embodiments of the present disclosure may be implemented as a computer software program. For example, embodiments of the present disclosure include a computer program product including a computer program carried on a computer-readable storage medium. The computer program includes a program code for execution of the method shown in the flowchart. In such embodiments, the computer program may be downloaded and installed from the network through the communication part 809, and/or installed from the removable medium 811. When the computer program is executed by the processor 801, the above-mentioned functions defined in the system of embodiments of the present disclosure are performed. According to embodiments of the present disclosure, the above-described systems, apparatuses, devices, modules, units, etc. may be implemented by computer program modules.

The present disclosure further provides a computer-readable storage medium, which may be included in the apparatus/device/system described in the above embodiments: or exist alone without being assembled into the apparatus/device/system. The above-mentioned computer-readable storage medium carries one or more programs that when executed, perform the methods according to embodiments of the present disclosure.

According to embodiments of the present disclosure, the computer-readable storage medium may be a non-transitory computer-readable storage medium, for example, may include but not limited to: a portable computer disk, a hard disk, a random access memory (RAM), a read-only memory (ROM), an erasable programmable read-only memory (EPROM or flash memory), a portable compact disk read-only memory (CD-ROM), an optical storage device, a magnetic storage device, or any suitable combination of the above. In the present disclosure, the computer-readable storage medium may be any tangible medium that contains or stores programs that may be used by or in combination with an instruction execution system, apparatus or device.

For example, according to embodiments of the present disclosure, the computer-readable storage medium may include the above-mentioned ROM 802 and/or RAM 803 and/or one or more memories other than the ROM 802 and RAM 803.

Embodiments of the present disclosure further include a computer program product, which contains a computer program. The computer program contains program code for performing the method provided by the embodiments of the present disclosure. When the computer program product runs on an electronic device, the program code causes the electronic device to implement the method of training the classification model and the classification method provided in embodiments of the present disclosure.

When the computer program is executed by the processor 801, the above-mentioned functions defined in the system/apparatus of the embodiments of the present disclosure are performed. According to the embodiments of the present disclosure, the above-described systems, apparatuses, modules, units, etc. may be implemented by computer program modules.

In an embodiment, the computer program may rely on a tangible storage medium such as an optical storage device and a magnetic storage device. In another embodiment, the computer program may also be transmitted and distributed in the form of signals on a network medium, downloaded and installed through the communication part 809, and/or installed from the removable medium 811. The program code contained in the computer program may be transmitted by any suitable medium, including but not limited to a wireless one, a wired one, or any suitable combination of the above.

According to the embodiments of the present disclosure, the program code for executing the computer programs provided by the embodiments of the present disclosure may be written in any combination of one or more programming languages. In particular, these computing programs may be implemented using high-level procedures and/or object-oriented programming languages, and/or assembly/machine languages. Programming languages include, but are not limited to, Java, C++, Python, “C” language or similar programming languages. The program code may be completely executed on the user computing device, partially executed on the user device, partially executed on the remote computing device, or completely executed on the remote computing device or server. In a case of involving a remote computing device, the remote computing device may be connected to a user computing device through any kind of network, including a local area network (LAN) or a wide area networks (WAN), or may be connected to an external computing device (e.g., through the Internet using an Internet service provider).

The flowcharts and block diagrams in the accompanying drawings illustrate the possible architecture, functions, and operations of the system, method, and computer program product according to various embodiments of the present disclosure. In this regard, each block in the flowcharts or block diagrams may represent a part of a module, a program segment, or a code, which part includes one or more executable instructions for implementing the specified logical function. It should be further noted that, in some alternative implementations, the functions noted in the blocks may also occur in a different order from that noted in the accompanying drawings. For example, two blocks shown in succession may actually be executed substantially in parallel, or they may sometimes be executed in a reverse order, depending on the functions involved. It should be further noted that each block in the block diagrams or flowcharts, and the combination of blocks in the block diagrams or flowcharts, may be implemented by a dedicated hardware-based system that performs the specified functions or operations, or may be implemented by a combination of dedicated hardware and computer instructions. Those skilled in the art may understand that the various embodiments of the present disclosure and/or the features described in the claims may be combined in various ways, even if such combinations are not explicitly described in the present disclosure. In particular, without departing from the spirit and teachings of the present disclosure, the various embodiments of the present disclosure and/or the features described in the claims may be combined in various ways. All these combinations fall within the scope of the present disclosure.

Embodiments of the present disclosure have been described above. However, these embodiments are for illustrative purposes only, and are not intended to limit the scope of the present disclosure. Although the various embodiments have been described separately above, this does not mean that measures in the respective embodiments may not be used in combination advantageously. The scope of the present disclosure is defined by the appended claims and their equivalents. Those skilled in the art may make various substitutions and modifications without departing from the scope of the present disclosure, and these substitutions and modifications should all fall within the scope of the present disclosure.

1. A method of training a classification model, comprising:
processing first sample data by using an auto-encoding module, so as to obtain reconstructed sample data, wherein the auto-encoding module comprises at least one autoencoder, the autoencoder comprises an encoder and a decoder, and the first sample data comprises medical sample data;
processing first sample feature data of the first sample data by using a classification module, so as to obtain a first sample classification result;
jointly training the auto-encoding module and the classification module according to the first sample data, the reconstructed sample data, the first sample classification result, and a first sample classification label value of the first sample data; and
obtaining the classification model according to the trained encoder and the trained classification module.

2. The method according to claim 1, wherein the processing first sample data by using an auto-encoding module, so as to obtain reconstructed sample data comprises:
processing the first sample data by using at least one encoder, so as to obtain first sample feature data; and
processing the first sample feature data by using at least one decoder, so as to obtain the reconstructed sample data.

3. The method according to claim 2, wherein the classification module comprises at least one classifier, and the first sample feature data comprises at least one first sample feature dimension data; and
wherein the processing first sample feature data of the first sample data by using a classification module, so as to obtain a first sample classification result comprises:
processing the first sample feature dimension data corresponding to the at least one classifier by using the at least one classifier, so as to obtain the first sample classification result.

4. The method according to claim 1, wherein the classification model comprises a first attention module;
wherein the method further comprises:
processing the first sample feature data of the first sample data by using the first attention module, so as to obtain first weighted sample feature data; and
wherein the processing first sample feature data of the first sample data by using a classification module, so as to obtain a first sample classification result comprises:
processing the first weighted sample feature data by using the classification module, so as to obtain the first sample classification result.

5. The method according to claim 1, wherein the first sample feature data comprises a plurality of first sample feature dimension data;
wherein the method further comprises:
determining at least one first sample feature dimension data from the plurality of first sample feature dimension data based on a feature selection method; and
obtaining second sample feature data based on the at least one first sample feature dimension data; and
wherein the processing first sample feature data of the first sample data by using a classification module, so as to obtain a first sample classification result comprises:
processing the second sample feature data by using the classification module, so as to obtain the first sample classification result.

6. The method according to claim 5, wherein the determining at least one first sample feature dimension data from the plurality of first sample feature dimension data based on a feature selection method comprises:
determining, based on an importance evaluation strategy, an importance evaluation value corresponding to the plurality of first sample feature dimension data, so as to obtain a plurality of importance evaluation values, wherein the importance evaluation value indicates an importance of the first sample feature dimension data; and
determining the at least one sample feature dimension data from the plurality of first sample feature dimension data according to the plurality of importance evaluation values.

7. The method according to claim 5, wherein the classification model comprises a second attention module;
wherein the method further comprises:
processing the second sample feature data by using the second attention module, so as to obtain second weighted sample feature data; and
wherein the processing the second sample feature data by using the classification module, so as to obtain the first sample classification result comprises:
processing the second weighted sample feature data by using the classification module, so as to obtain the first sample classification result.

8. The method according to claim 1, wherein the jointly training the auto-encoding module and the classification module according to the first sample data, the reconstructed sample data, the first sample classification result, and a first sample classification label value of the first sample data comprises:
obtaining a first output value according to the first sample data and the reconstructed sample data based on a first loss function;
obtaining a second output value according to the first sample classification result and the first sample classification label value based on a second loss function; and
adjusting a model parameter of the auto-encoding module and a model parameter of the classification module according to the first output value and the second output value.

9. The method according to claim 8, wherein the obtaining a second output value according to the first sample classification result and the first sample classification label value based on a second loss function comprises:
obtaining the second output value according to the first sample classification result and the first sample classification label value based on a third loss function, wherein the third loss function is determined according to the second loss function and a first penalty term.

10. The method according to claim 1, further comprising:
processing second sample data by using an encoder of the classification model, so as to obtain third sample feature data; and
optimizing the classification module of the classification model by using the third sample feature data.

11. The method according to claim 10, wherein the third sample feature data comprises a plurality of second sample feature dimension data;
wherein the optimizing the classification module of the classification model by using the third sample feature data comprises repeatedly performing operations until a performance test result of the classification module meets a predetermined performance condition, and the operations comprise:
testing a model performance of the classification module by using candidate sample feature data, so as to obtain the performance test result; and
determining, in response to determining that the performance test result does not meet the predetermined performance condition, at least one second sample feature dimension data from the plurality of second sample feature dimension data, so as to obtain new candidate sample feature data.

12. The method according to claim 10, wherein the optimizing the classification module of the classification model by using the third sample feature data comprises:
processing the third sample feature data by using the classification module, so as to obtain a second sample classification result;
obtaining a third output value according to the second sample classification result and a second sample classification label value of the second sample data based on a fourth loss function, wherein the fourth loss function is determined according to the second loss function and a second penalty term; and
adjusting a model parameter of the classification module according to the third output value.

13. The method according to claim 10, wherein the classification model comprises a third attention module;
wherein the method further comprises:
processing the third sample feature data by using the third attention module, so as to obtain third weighted sample feature data; and
wherein the optimizing the classification module of the classification model by using the third sample feature data comprises:
optimizing the classification module by using the third weighted sample feature data.

14. The method according to claim 1, wherein the medical sample data comprises at least one of multi-omics sample data or medical sample image data.

15. The method according to claim 14, wherein the multi-omics sample data comprise tumor multi-omics sample data, and the classification model is configured to determine a type of tumor.

16. A classification method, comprising:
acquiring target data, wherein the target data comprises medical target data; and
inputting the target data into a classification model to obtain a classification result, wherein the classification model is trained using the method of claim 1.

17. The method according to claim 16, wherein the medical target data comprises at least one of multi-omics target data or medical target image data.

18. An electronic device, comprising:
one or more processors; and
a memory for storing one or more programs, wherein the one or more programs are configured to, when executed by the one or more processors, cause the one or more processors to implement the method of claim 1.

19. A computer readable storage medium having executable instructions therein, wherein the instructions are configured to, when executed by a processor, cause the processor to implement the method of claim 1.

20. (canceled)
